(19) United States
(12) Patent Application Publication
(10) Pub. No.: US 2026/0296392 A1
(43) Pub. Date: Oct. 1, 2026

(54) AIR DRYING ASSEMBLY, AIR PROCESSING UNIT, PNEUMATIC ARRANGEMENT, BRAKING ARRANGEMENT AND COMMERCIAL VEHICLE

(71) Applicant: ZF CV SYSTEMS GLOBAL GMBH, Bern (CH)

(72) Inventors: Sudhagar GANESAN, Namakkal (IN); Sahul Hameed THAMEESDEEN, Chennai (IN); Thangavel RAJALINGAM, Chennai (IN)

(21) Appl. No.: 19/479,634

(22) PCT Filed: Apr. 25, 2024
(86) PCT No.: PCT/EP2024/061382

§ 371 Date: Oct. 28, 2025

(30) Foreign Application Priority Data
May 15, 2023 (IN) 202311034065

(51) Int. Cl. B60T 17/00; B01D 53/26; B60T 13/68

(52) U.S. Cl. CPC B60T 17/004; B01D 53/261; B60T 13/683; B01D 2257/80; B01D 2259/40003

(57) ABSTRACT

An air drying assembly includes an inlet port for receiving compressed air, an air drying unit for outputting the dried compressed air, and an outlet port for providing the dried compressed air to a pneumatic unit. The air drying assembly also includes a pressure discharge line for discharging air pressure (P) in the air drying assembly, via a pressure discharge port, to an environment, wherein a flow of discharge air to the environment is controlled by an electrically controllable valve unit. The pressure discharge line is connected to the output port of the air drying unit, which reduces the corrosion of the valve unit.

The present invention is directed to a drying assembly for providing dried air to a pneumatic unit of a pneumatic arrangement. Additionally, the invention is directed to an air processing unit, to a pneumatic arrangement, to a braking arrangement and to a commercial vehicle.

In known pneumatic arrangements, for instance in pneumatic braking arrangements of commercial vehicles, compressed air is provided by a compressed air supply unit, such as a compressor. The compressed air is dried at an air drying assembly so that the compressed air delivered to the pneumatic units is dried. Typically, a pressure discharge line is connected to the air dryer inlet port in order to discharge the air pressure in the line connecting the compressor to the air drying assembly. The flow of air through the pressure discharge line is controlled by a discharge control valve. In the case of electronic compressor, the valve is typically a solenoid valve which enables a pneumatic connection between its input and output port when the vehicle is switched off, thereby discharging the pressure in the line and avoiding an initial high torque on the compressor motor during a subsequent vehicle switch on.

Document DE 10 2020 108 654 A1 shows a pneumatic system with a compressed air supply system. The compressed air supply system comprises a venting valve arrangement that is arranged in a discharge line between the compressed air supply unit and an exhaust port.

The inventors have realized that the commonly used discharge control valves are subject to a reduced lifetime due to rust, especially in humid environments. Failure investigations have shown that the rust in the valve is due to water entry.

This is where the invention comes in, wherein it is an objective of the present invention to enable a longer operation life time of the valve unit controlling the flow through the pressure discharge line.

This objective is achieved in a first aspect by the invention by an air drying assembly apparatus according to claim 1. According a first aspect of the present invention, an air drying assembly is presented. The air drying assembly is suitable for providing dried air to a pneumatic unit of a pneumatic arrangement, wherein the pneumatic unit and the pneumatic arrangement are not necessarily part of the inventive air drying assembly of the first aspect.

The air drying assembly comprises an inlet port that is configured to be connected to a compressed air supply unit for receiving compressed air. The air drying assembly also includes an air drying unit comprising an input port connected to the inlet port, a desiccant element arranged and configured to absorb moisture from the received compressed air, and an output port for outputting the dried air. The desiccant element is pneumatically arranged between the input port and the output port. The air drying assembly also comprises an outlet port for providing the dried air to the pneumatic unit.

The air drying assembly also comprises a pressure discharge line for discharging air pressure in the air drying assembly, via a pressure discharge port, to an environment. A flow of air to the environment is controlled by an electrically controllable valve unit.

According to the invention, the pressure discharge line is connected to the output port of the air drying unit. By shifting the connection of the pressure discharge line from a position upstream of the air drying unit to a position downstream of the air drying unit, the desiccant element can be advantageously used to also dry the air to be discharged, thereby reducing the amount of moisture in the air flowing through the electrically controllable valve unit and increasing its operational life time without a reduction of its performance.

Further advantageous developments of the invention are found in the dependent claims and indicate in detail advantageous possibilities to realize the concept described above within the scope of the object as well as with regard to further advantages. In the following, developments of the air drying assembly of the first aspect will be discussed.

In a preferred development, the electrically controlled valve unit is an electrically controlled solenoid valve. More preferably, the electrically controlled valve unit is a 2-2-way solenoid valve having a first port connected to the output port of the air drying unit and a second port connected to the environment. In particular, in another development, the electrically controlled solenoid valve is a normally-open solenoid valve configured to receive a control signal indicative of a switched-on state of the compressor, or, in another embodiment, of a switched on state of the vehicle. This is particularly advantageous in the case of an electronically controlled compressor and/or of an electric vehicle. The control signal can be indicative of a vehicle switched on state or of a compressor switched on state. Thus, when the vehicle or the compressor is in an on-state, the normally open electrically controlled valve is in its actuated state and a pneumatic path to the environment via the pressure discharge line is closed. When the control signal is indicative of an off-state of the vehicle or of the compressor, the electrically controlled solenoid valve is not energized and returns to the normally open position enabling the discharge of the pressure remaining in the main line, i.e. the supply line pneumatically connecting the compressed air supply unit to the pneumatic unit.

In another development, the inventive air drying assembly further comprises a filter unit arranged between the inlet port and the air drying unit and configured to filter the compressed air. This also reduces or even prevents the presence of solid particles in the flow of air passing through the electrically controllable valve unit, which further increases its operational life-time.

In another development, the air drying assembly further comprises an exhaust line that is connected to the inlet port and to an exhaust port. A flow of exhaust air to the exhaust port via the exhaust line is controlled by an exhaust valve unit. The exhaust valve unit is configured to enable the flow of exhaust air upon reception of an exhaust request signal. Said exhaust request signal can be a pneumatic signal or an electric signal.

In this particular development, the air drying assemble comprises a purge tank that is connected to the output port of the air drying unit and that is configured to store compressed dried air during a drying phase of the air drying assembly, and to provide the stored compressed dried air during a regeneration phase of the air drying assembly.

During the regeneration phase, clean dried air is therefore used to remove moisture from the desiccant element, and, optionally, dust or particles from the filter unit, which are then exhausted via the exhaust port. Preferably, the exhaust valve is a pneumatically controlled valve, to avoid water corrosion caused by water present in the exhaust air during the regeneration phase.

Thus, in the regeneration phase, the compressed dried air provided or supplied by the purge tank is directed to the exhaust port via the air drying unit in a regeneration flow direction from the output port to the input port of the air drying unit.

In another development, the purge tank is connected in parallel to the pressure discharge line. Alternatively, in another development, the purge tank is arranged in the pressure discharge line between the output port and electrically controllably valve unit.

A second aspect of the present invention is formed by an air processing unit. The inventive air processing unit comprises an air drying assembly according to the first aspect of the invention and a multi-circuit protection valve unit. The multi-circuit protection valve unit includes an inlet port that is connected to the outlet port of the air drying assembly and also includes a plurality of output ports for connection to respective pneumatic units, in particular of a pneumatic braking system. The air processing unit of the second aspect of the invention is therefore designed to efficiently dry, clean and distribute the compressed air provided by the compressed air supply unit (e.g. a compressor) into the different circuits of a vehicle's braking system combining the features of an air drying assembly and a multi-circuit protection valve. The multi-circuit protection valve unit is configured to provide pressure protection in multi-circuit braking systems. It is commonly used in a trailer braking system. The multi-circuit protection valve unit is configured and designed to distribute compressed air, adjust air pressure to the respective circuits and protect healthy circuits in cases of circuit failure.

A third aspect of the present invention is formed by a pneumatic arrangement. The inventive pneumatic arrangement comprises a compressed air supply unit, for instance a compressor, in particular an electrically controlled compressor, which is configured to generate and provide compressed air. The pneumatic arrangement also comprises an air drying assembly according to the first aspect of the invention, or an air processing unit according to the second aspect of the invention. Additionally, the pneumatic arrangement comprises at least one pneumatic unit that is configured to receive dried compressed air from the air drying assembly or from the air processing unit, in particular via the output ports of the multi-circuit protection valve unit.

A fourth aspect of the present invention is formed by a breaking arrangement, in particular for a commercial vehicle. The braking arrangement comprises a pneumatic arrangement according to the third aspect, wherein at least one of the pneumatic units is a braking unit configured to exert a braking force upon receiving compressed dried air.

A fifth aspect of the present invention is formed by a commercial vehicle comprising an air drying assembly according to the first aspect, or an air processing unit according to the second aspect or a pneumatic arrangement according to the third aspect or a braking arrangement according to the fourth aspect.

These and other aspects of the invention will be apparent from and elucidated with reference to the embodiments described hereinafter.

The embodiments of the invention are described in the following on the basis of the drawing in comparison with the state of the art, which is also partly illustrated. The latter is not necessarily intended to represent the embodiments to scale. The drawing is, where useful for explanation, shown in schematized and/or slightly distorted form. With regard to additions to the teaching immediately recognizable from the drawing, reference is made to the relevant prior art. It should be kept in mind that numerous modifications and changes can be made to the form and detail of an embodiment without deviating from the general concept of the invention. The features of the invention disclosed in the description, in the drawing and in the claims may be essential for a further development of the invention, either individually or in any combination. In addition, all combinations of at least two of the features disclosed in the description, drawing and/or claims fall within the scope of the invention.

The general concept of the invention is not limited to the exact form or detail of the preferred embodiments shown and described below or to a subject matter, which would be limited in comparison to the subject matter as claimed in the claims.

For specified design ranges, values within specified limits of the ranges are also disclosed as limit values and thus are arbitrarily applicable and claimable.

The following drawing shows in:

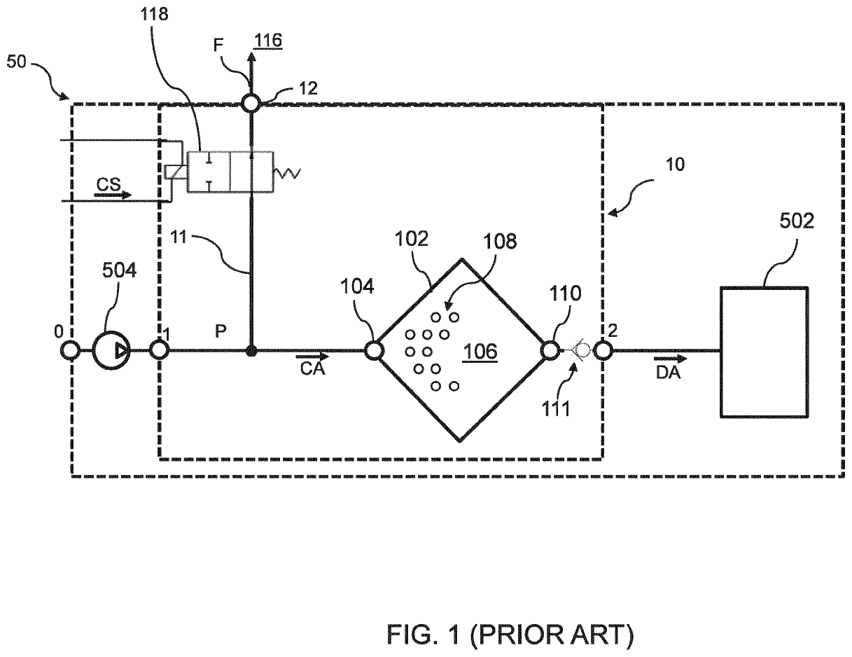

FIG. 1 a schematic block diagram of a known pneumatic arrangement with a pressure discharge line connected to the input of the air drying assembly;

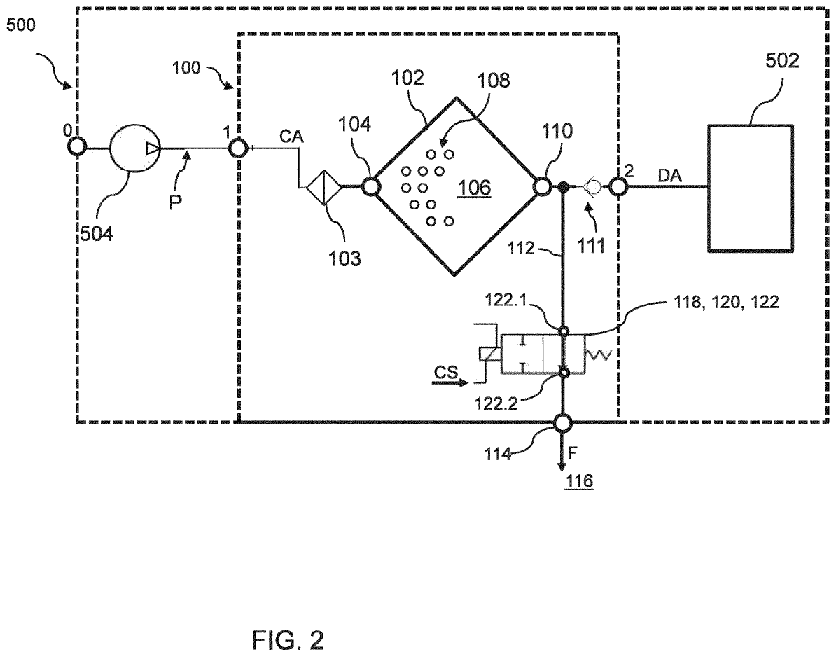

FIG. 2 a schematic block diagram of a pneumatic arrangement in accordance with a first embodiment of the invention;

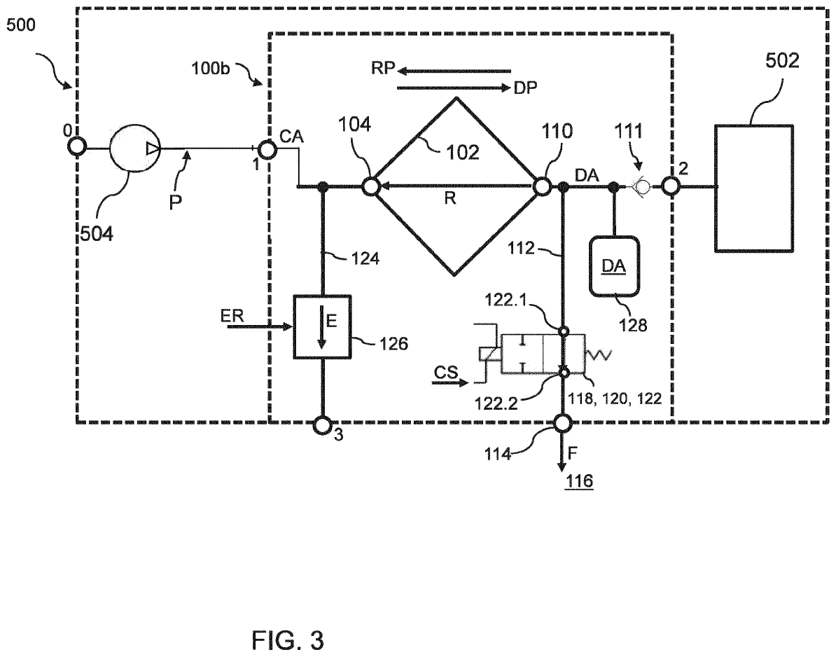

FIG. 3 a schematic block diagram of a pneumatic arrangement in accordance with a second embodiment of the invention;

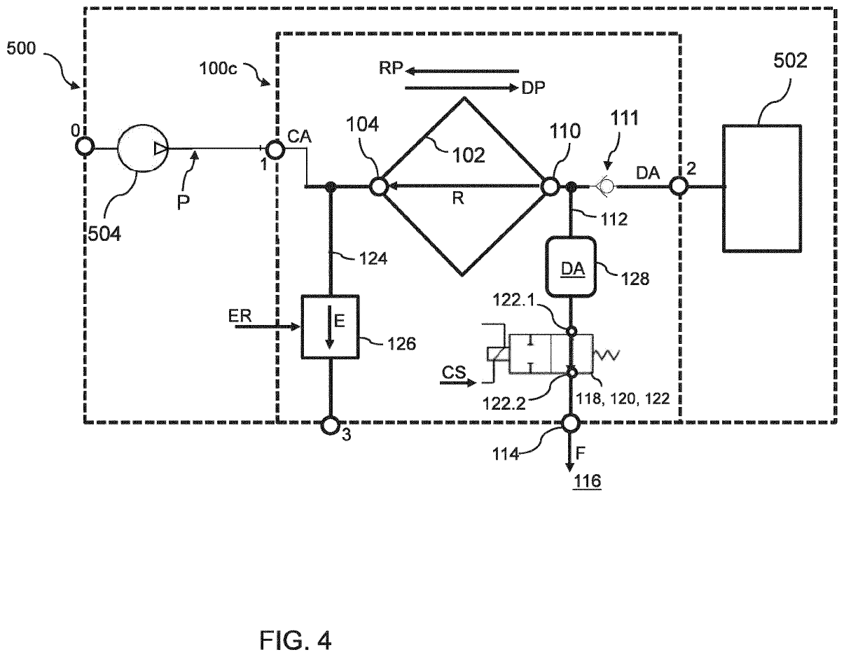

FIG. 4 a schematic block diagram of a pneumatic arrangement in accordance with a third embodiment of the invention;

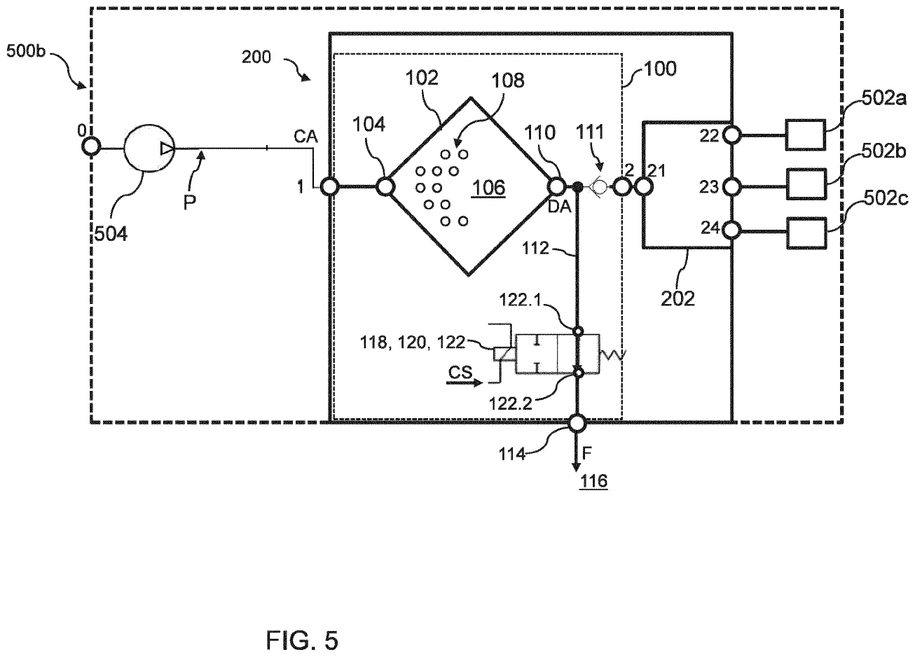

FIG. 5 a schematic block diagram of a pneumatic arrangement in accordance with a fourth embodiment of the invention;

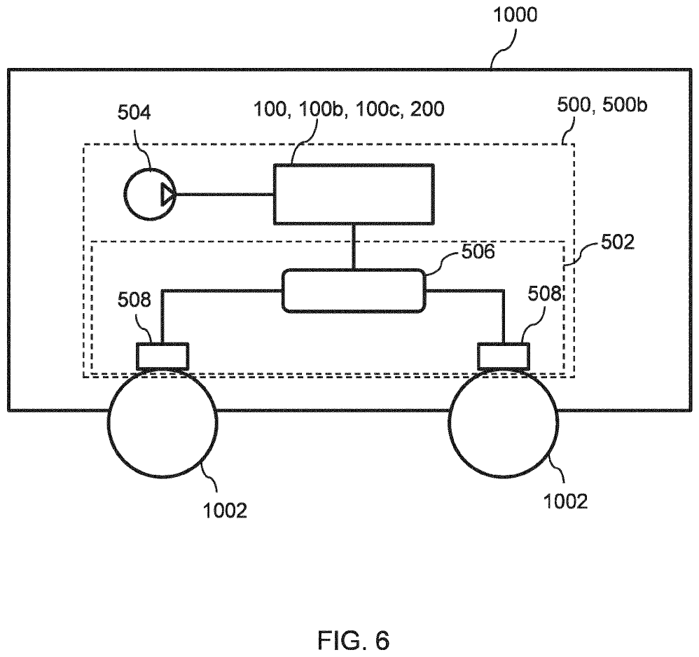

FIG. 6 a schematic block diagram of a commercial vehicle in accordance with an embodiment of the invention.

FIG. 1 shows a schematic block diagram of a known pneumatic arrangement 50 with a pressure discharge line 11 connected to the input, or inlet port 1, of an air drying assembly 10. The air drying assembly 10 is configured to receive compressed air CA, which is provided by a compressor 504, to dry said received compressed air CA and to provide dried compressed air to a pneumatic unit 502 of the pneumatic arrangement 50. The air drying assembly 10 comprises an inlet port 1 that is configured to be connected to the compressor 504, or to an equivalent compressed air supply unit, for receiving the com-pressed air CA, an air drying unit 102 comprising an input port 104 connected to the inlet port 1, a desiccant element 106 arranged and configured to absorb moisture 108 from the received compressed air CA, and an output port 110 for outputting the dried compressed air DA. The desiccant element 106 is pneumatically arranged between the input port 104 and the output port 110, meaning that the pneumatic path between the input port 104 and the output port 110 transverses the desiccant element 108. The air drying assembly 10 also comprises an outlet port 2 for providing the dried compressed air DA to the pneumatic unit 502. A non-return valve 111 may be included to prevent a backwards flow of air from the pneumatic unit 502 towards the air drying unit 102. As stated above, the air drying assembly 10 also comprises a pressure discharge line 11 for discharging air pressure P in the air drying assembly 10, via a pressure discharge port 12, to an environment 116. A flow of discharge air F to the environment 116 is con-trolled by an electrically controllable valve unit 118. The pressure discharge line is used to discharge the air pressure P in the line linking the compressor 504 to the air drying assembly 10, especially after vehicle switch off condition. This avoids an initial high torque acting in the compressor's motor when after a subsequent switch on condition. However, the electrically controllable valve unit 118 controlling the flow along the pressure discharge is subject to rust due to water entry caused by the valve unit being operated with ambient air.

FIG. 2 shows a schematic block diagram of a pneumatic arrangement 500 in accordance with a first embodiment of the invention. Those technical features of the pneumatic arrangement 500 of FIG. 2 that have an identical or similar functionality to those discussed with reference to the pneumatic arrangement 50 of FIG. 1 will be referred to using the same reference signs. The pneumatic arrangement 500 of FIG. 2 comprises a compressed air supply unit, for instance, a compressor 504, which is configured to generate and provide compressed air CA for operation of the pneumatic unit 502 of the pneumatic arrangement 500. The pneumatic arrangement also comprises an air drying assembly 100 and a pneumatic unit 502 that is configured to receive dried compressed air DA from the air drying assembly 100. Similarly to the air drying assembly 10 of FIG. 1, the air drying assembly 100 of FIG. 2 comprises an inlet port 1 configured to be connected to the compressed air supply unit 504 for receiving compressed air CA, an air drying unit 102 comprising an input port 104 connected to the inlet port 1, a desiccant element 106 arranged and configured to absorb moisture 108 from the received compressed air CA, and an output port 110 for outputting the dried com-pressed air DA, and an outlet port 2 for providing the dried compressed air DA to the pneumatic unit 502.

Here again, the desiccant element 106 is pneumatically arranged between the input port 104 and the output port 110.

The air drying assembly 100 also comprises a pressure discharge line 112 for discharging air pressure P in the air drying assembly, via a pressure discharge port 114, to an environment 116. The a flow of discharge air F to the environment 116 is controlled by an electrically controllable valve unit 118. Contrary to the air drying assembly 10 of FIG. 1, in the air drying assembly 100 of FIG. 2, the pressure discharge line 112 is connected to the output port 110 of the air drying unit 102. Thus, the flow of discharge air that passes through the valve unit 118 has already passed through the air drying unit 102, which reduces the amount of moisture in said flow of air F and the corrosion of the electrically controllable valve unit 118 is avoided or at least significantly reduced so that the operational life time of said valve unit 118 is extended.

In particular, the electrically controlled valve unit 118 of FIG. 2 is an electrically controlled solenoid valve 120. In this specific example the electrically controlled solenoid valve 120 is a 2/2-way solenoid valve 122 that has a first port 122.1 connected to the output port 110 of the air drying unit 102 and a second port 122.2 connected to the environment 116, which is controlled by the provision of a control signal CS. In this particular air drying assembly 100, the electrically controlled solenoid valve is a normally-open solenoid valve configured to receive a control signal CS indicative of a switched-on state of the compressor, or, in the case of implementing the pneumatic arrangement in a vehicle, the control signal can be indicative of a switch state (off/on) of the vehicle.

When the control signal is present, the solenoid valve 122 is energized and the pneumatic path along the pressure discharge line 112 is blocked. In this case, the air provided by the compressor 504 is dried and fed to the pneumatic unit. When the control signal is no longer pressure, for instance because the compressor, or the vehicle is switched off, the pressure P accumulated in the main line between the compressor 504 and a non-return valve 111 can be discharged via the pressure discharge line 112. The main line is the supply line that links the compressor to the pneumatic unit.

Optionally, the air drying assembly 100 may comprising a filter unit 103 arranged between the inlet port 1 and the air drying unit 102 and configured to filter the compressed air CA and thereby remove dust or other particles.

FIG. 3 shows a schematic block diagram of a pneumatic arrangement 500 including an air drying assembly 100b in accordance with a second embodiment of the invention. For the following discussion, the same reference signs will be used for those features that have an identical or similar functionality to those discussed with reference to FIGS. 1 and 2. The drying assembly 100b of FIG. 3 further comprises an exhaust line 124 that is connected to the inlet port 1 and to an exhaust port 3. A flow of exhaust air E to the exhaust port 3 is controlled by an exhaust valve unit 126 that is configured to enable the flow of exhaust air E upon reception of an exhaust request signal ER. The exhaust valve unit may comprise one or more pneumatically controlled valves, electrically controlled valves or a combination of pneumatically and electrically controlled valves. The air drying assembly also comprises a purge tank 128 that is connected to the output port 110 of the air drying unit 102 and configured to store compressed dried air DA, for instance during a drying phase DP of the air drying assembly 100b, and to provide the stored compressed dried air DA during a regeneration phase RP or purging phase of the air drying assembly 100b. In fact, in the regeneration phase RP, the compressed dried air DA provided by the purge tank 128 is directed to the exhaust port 3 via the air drying unit in a regeneration flow direction R from the output port 110 to the input port 104 of the air drying unit 102.

The regeneration phase is advantageously used to regenerate the desiccant material. The dried compressed air interacts with the desiccant material and carries away part of the humidity stored, which is then exhausted via the exhaust port 3. In the exemplary embodiment shown in FIG. 3, the purge tank 128 is connected in parallel to the pressure discharge line 112.

FIG. 4 shows a schematic block diagram of a pneumatic arrangement 500 including an air drying assembly 100c in accordance with a third embodiment of the invention. In particular, the purge tank 128 is now connected in the pressure discharge line 112 between the output port 110 of the air drying unit 102 and the electrically controllable valve unit 118. The pneumatic arrangement 500 of FIG. 4 is otherwise analogous to that of FIG. 3 and the reader is referred to the discussion of FIG. 3 for a comprehensive explanation of the features shown in FIG. 4.

FIG. 5 shows a schematic block diagram of a pneumatic arrangement in accordance with a fourth embodiment of the invention. The pneumatic arrangement of FIG. 5 is exemplarily configured as a braking arrangement 500b and includes an air processing unit —APU-200. The APU 200 exemplarily comprises an air drying assembly 100 as previously described with reference to FIG. 2. However, alternative APU's may comprise other embodiments of air drying assemblies according to the invention, such as, for example, air drying assembly 100b of FIG. 3 or air drying assembly 100c of FIG. 4. In any case, the air processing unit 200 comprises a multi-circuit protection valve unit 202 having an inlet port 21 connected to the outlet port 2 of the air drying assembly 100 (or 100b, or 100c) and a plurality of output ports 22, 23, 24 for connection to respective pneumatic units 502a, 502b, 502c of the pneumatic braking system 500b. The multi-circuit protection valve unit 202 is, in this particular example, a three circuit protection valve. Alternatively, the multi-circuit protection valve unit may be a four circuit protection valve. Multi-circuit protection valve units typically comprise (not shown) one or more integrated pressure limiting valves and a plurality of check valves and is used to limit and guard the pressure in multiple-circuit braking arrangements.

FIG. 6 shows a schematic block diagram of a commercial vehicle 1000 in accordance with an embodiment of the invention. The commercial vehicle 100 comprises a pneumatic arrangement 500, which can be configured as a braking arrangement 500b, which in turn comprises an air drying assembly 100, 100b, 100c, or an air processing unit 200. The vehicle compressor 504 is configured to provide compressed air, which is dried by the air drying assembly 100 and stored in one or more compressed air storage units 506, from where it is provided for operation of the braking units 508, which are configured to apply a braking force to the wheels 1002 of the vehicle 1000. The combination of the compressed air storage unit 506 and the braking units 508 which receive dried compressed air for their operation therefrom, is labelled as an exemplary pneumatic unit 502.

In summary, the invention is directed to an air drying assembly comprising an inlet port for receiving compressed air an air drying unit for outputting the dried compressed air, and an outlet port for providing the dried compressed air to a pneumatic unit. The air drying assembly also comprises a pressure discharge line for discharging air pressure in the air drying assembly, via a pressure discharge port, to an environment, wherein a flow of discharge air to the environment is controlled by an electrically controllable valve unit. According to the invention, the pressure discharge line is connected to the output port of the air drying unit, which reduces the corrosion of the valve unit.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Any reference signs in the claims should not be construed as limiting the scope.

### REFERENCE LIST (PART OF THE DESCRIPTION)

1 Inlet port
2 Outlet port
3 Exhaust port
10 Known air drying assembly
11 Pressure discharge line
12 Pressure discharge port
21 Inlet port of multi-circuit protection valve unit
22 Output port of multi-circuit protection valve unit
23 Output port of multi-circuit protection valve unit
24 Output port of multi-circuit protection valve unit
50 Known pneumatic arrangement
100 Air drying assembly
100b Air drying assembly
100c Air drying assembly
102 Air drying unit
103 Filter unit
104 Input port of air drying unit
106 Desiccant element
108 Moisture
110 Output port of air drying unit
111 Non-return valve
112 Pressure discharge line
114 Pressure discharge port
116 Environment
118 Electrically controllable valve unit
120 Electrically controlled solenoid valve
122 2/2-way solenoid valve
122.1 First port of solenoid valve
122.2 Second port of solenoid valve
124 Exhaust line
126 Exhaust valve unit
128 Purge tank
200 Air processing unit—APU-
202 Multi-circuit protection valve unit
500 Pneumatic arrangement
500b Braking arrangement
502 Pneumatic unit
502a Pneumatic unit
502b Pneumatic unit
502c Pneumatic unit
504 Compressed air supply unit; Compressor
506 Compressed air storage unit
508 Braking unit
1000 commercial vehicle
1002 Wheel
CA Compressed air
CS Control signal
DA Dried compressed air
DP Drying phase
E Flow of exhaust air
ER Exhaust request signal
F Flow of discharge air
P Air pressure in main line
R Regeneration flow direction
RP Regeneration phase

1. An air drying assembly for providing dried air to a pneumatic unit of a pneumatic arrangement, the air drying assembly comprising:
an inlet port configured to be connected to a compressed air supply unit for receiving compressed air;
an air drying unit comprising an input port connected to the inlet port, a desiccant element arranged and configured to absorb moisture from the received compressed air, and an output port for outputting the dried compressed air, wherein the desiccant element is pneumatically arranged between the input port and the output port; and
an outlet port for providing the dried compressed air to the pneumatic unit, wherein the air drying assembly also comprises
a pressure discharge line for discharging air pressure in the air drying assembly, via a pressure discharge port, to an environment, wherein a flow of discharge air to the environment is controlled by an electrically controllable valve unit; wherein the pressure discharge line is connected to the output port of the air drying unit.

2. The air-drying assembly of claim 1, wherein the electrically con-trolled valve unit is an electrically controlled solenoid valve.

3. The air drying assembly of claim 1, wherein the electrically controlled valve unit is a 2/2-way solenoid valve having a first port connected to the output port of the air drying unit and a second port connected to the environment.

4. The air-drying assembly of claim 2, wherein the electrically controlled solenoid valve is a normally-open solenoid valve configured to receive a control signal indicative of a switched-on state of the compressor.

5. The air drying assembly of claim 1, further comprising a filter unit arranged between the inlet port and the air drying unit and configured to filter the compressed air.

6. The air drying assembly of claim 1, further comprising:
an exhaust line connected to the inlet port and to an exhaust port wherein a flow of exhaust air to the exhaust port is controlled by an exhaust valve unit configured to enable the flow of exhaust air upon reception of an exhaust request signal; and
a purge tank connected to the output port of the air drying unit and configured to store compressed dried air during a drying phase of the air drying assembly and to provide the stored compressed dried air during a regeneration phase of the air drying assembly and wherein
in the regeneration phase the compressed dried air provided by the purge tank is directed to the exhaust port via the air drying unit in a regeneration flow direction from the output port to the input port of the air drying unit.

7. The air drying assembly of claim 6, wherein the purge tank is connected in parallel to the pressure discharge line.

8. The air drying assembly of claim 6, wherein the purge tank is arranged in the pressure discharge line between the output port and electrically controllably valve unit.

9. Air processing unit comprising an air drying assembly according to claim 1 and a multi-circuit protection valve unit having an inlet port connected to the outlet port of the air drying assembly and a plurality of output ports for connection to respective pneumatic units, in particular of a pneumatic braking system.

10. Pneumatic arrangement comprising:
a compressed air supply unit configured to generate and provide compressed air;
an air drying assembly according to claim 1; and
at least one pneumatic unit configured to receive dried compressed air from the air drying assembly.

11. Breaking arrangement for a commercial vehicle, the braking arrangement comprising a pneumatic arrangement according to claim 10, wherein at least one of the pneumatic units is a braking unit configured to exert a braking force upon receiving compressed dried air.

12. Commercial vehicle comprising an air drying assembly according to claim 1.

13. Pneumatic arrangement comprising:
a compressed air supply unit configured to generate and provide compressed air;
an air processing unit according to claim 9; and
at least one pneumatic unit configured to receive dried compressed air from the air processing unit.

14. Breaking arrangement for a commercial vehicle, the braking arrangement comprising a pneumatic arrangement according to claim 13, wherein at least one of the pneumatic units is a braking unit configured to exert a braking force upon receiving compressed dried air.

15. Commercial vehicle comprising an air processing unit according to claim 9.

16. Commercial vehicle comprising a pneumatic arrangement according to claim 10.

17. Commercial vehicle comprising a pneumatic arrangement according to claim 13.

18. Commercial vehicle comprising a braking arrangement according to claim 11.

19. Commercial vehicle comprising a braking arrangement according to claim 14.
